(19) United States
(12) Patent Application Publication
(10) Pub. No.: US 2007/0033869 A1
(43) Pub. Date: Feb. 15, 2007

(54) NUTRIMENT SUPPLYING DEVICE FOR PLANTS

(76) Inventor: Tsun-Tsung Tsai, Dashe Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/461,216

(22) Filed: Jul. 31, 2006

(30) Foreign Application Priority Data
Aug. 12, 2005 (TW) 094213815

(51) Int. Cl. A01G 29/00

(52) U.S. Cl. 47/48.5

(57) ABSTRACT

A nutriment supplying device for plants includes a container, a cover and at least one positioning leg. The container includes an opening and a plurality of drain holes. The container receives fertilizer. The cover is mounted to the opening. The cover includes at least one liquid inlet through which liquid is filled into the container. The cover further includes a lid for opening and automatically closing the liquid inlet to allow a watering tool to fill the liquid and to keep insects out of the container, respectively. The liquid in the container dissolves the fertilizer and is then drained via the drain holes to provide nutriment for a potted plant.

### BACKGROUND OF THE INVENTION

1. Field of the Invention

The present invention relates to a nutriment supplying device. More particularly, the present invention relates to a nutriment supplying device for plants.

2. Description of Related Art

A typical cultivating method in agriculture includes breeding a seedling in a pot or like for a period of time and then moving the seedling that has grown to a desired state to a cultivation site. Potted plants are often used to decorate the environment as well as to create a view. Adequate fertilization is required for plants to grow well. An option is burying fertilizer into the soil of a potted plant. The temperature of the soil rises due to chemical reaction of the fertilizer buried in the soil, which might adversely affect growth of the plant. Another option is spreading the fertilizer 4 on the soil and then watering the soil to dissolve the fertilizer into the soil for absorption by the roots of the plant (see FIG. 1).

However, fertilizing a potted plant in this way has several disadvantages. First, the fertilizer 4 on the soil adversely affects the aesthetic impression of the whole environment where the potted plant is intended for decoration as well as creating a view. Secondly, the fertilizer 4 attracts insects and thus causes hygienic problems. Thirdly, the fertilizer 4 smells and thus degrades the quality and comfort of living. Lastly, since the fertilizer 4 merely spreads over the soil, the fertilizer 4 cannot dissolve sufficiently before it enters the soil, leading to poor nutriment for the plant.

### OBJECTS OF THE INVENTION

An object of the present invention is to provide a nutriment supplying device for receiving fertilizer and enhancing dissolution of fertilizer.

Another object of the present invention is to provide a nutriment supplying device including a container for receiving fertilizer while preventing from insects from entering the container.

A further object of the present invention is to provide a nutriment supplying device including a container for receiving fertilizer while allowing easy filling of water into the container.

### SUMMARY OF THE INVENTION

A nutriment supplying device for plants in accordance with the present invention comprises a container, a cover and at least one positioning leg. The container includes an opening and a plurality of drain holes. The container receives fertilizer. The cover is mounted to the opening. The cover includes at least one liquid inlet through which liquid is filled into the container. The cover further includes a lid for opening and automatically closing the liquid inlet to allow a watering tool to fill the liquid and to keep insects out of the container, respectively. The liquid in the container dissolves the fertilizer and is then drained via the drain holes to provide nutriment for a potted plant.

The nutriment supplying device may further comprise at least one support for retaining the lid in the liquid inlet.

The nutriment supplying device may further comprise a screen attached to the cover and behind the lid for preventing insects from entering the container via a gap between a perimeter wall defining the liquid inlet and the lid.

Alternatively, a screen is mounted in the liquid inlet for preventing insects from entering the container.

Preferably, the nutriment supplying device further comprises at least one coupling member for guiding and attaching the cover to the container.

Alternatively, the lid includes a recessed portion including a bottom wall with a plurality of liquid inlets.

Preferably, the container further includes at least one leg to be stuck into soil in a pot in which the potted plant is planted.

Preferably, the cover and the container together form a shape of an animal, a plant, or an artificial mountain to decorate the potted plant.

Other objects, advantages and novel features of this invention will become more apparent from the following detailed description when taken in conjunction with the accompanying drawings.

### BRIEF DESCRIPTION OF THE DRAWINGS

FIG. 1 is a perspective view illustrating conventional fertilization for a potted plant;

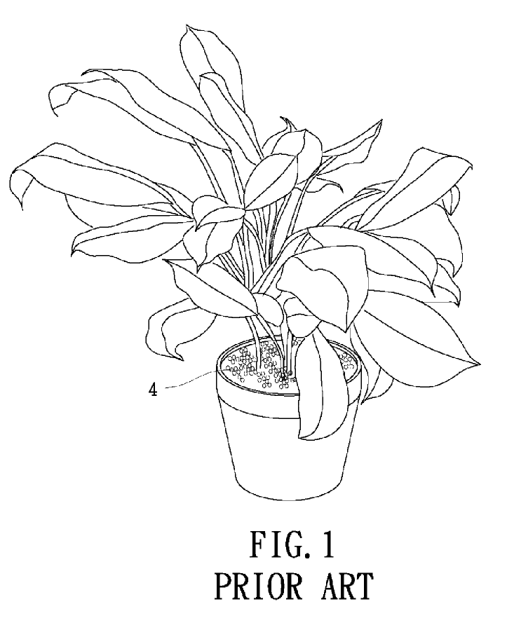

FIG. 2 is a perspective view of a potted plant and a first embodiment of a nutriment supplying device in accordance with the present invention;

FIG. 3 is an exploded view of the first embodiment of the nutriment supplying device in accordance with the present invention;

FIG. 4 is a sectional view of the first embodiment of the nutriment supplying device in accordance with the present invention, wherein fertilizer is placed into a container of the nutriment supplying device;

FIG. 5 is a view similar to FIG. 4, illustrating use of the nutriment supplying device;

FIG. 6 is an exploded perspective view illustrating a second embodiment of the nutriment supplying device in accordance with the present invention; and

FIG. 7 is a sectional view similar to FIG. 5, illustrating a third embodiment of the nutriment supplying device in accordance with the present invention.

### DETAILED DESCRIPTION OF THE PREFERRED EMBODIMENTS

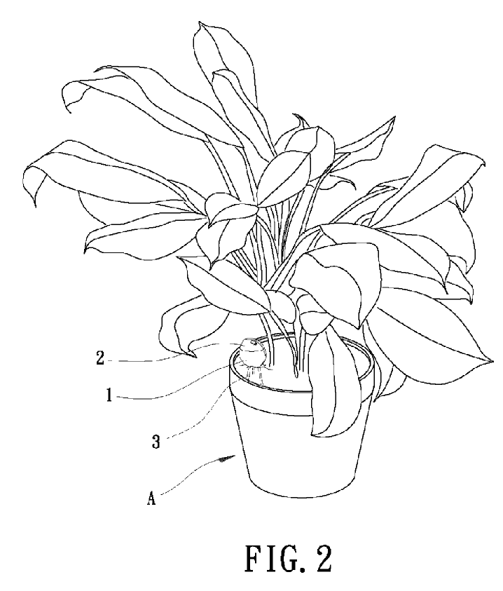

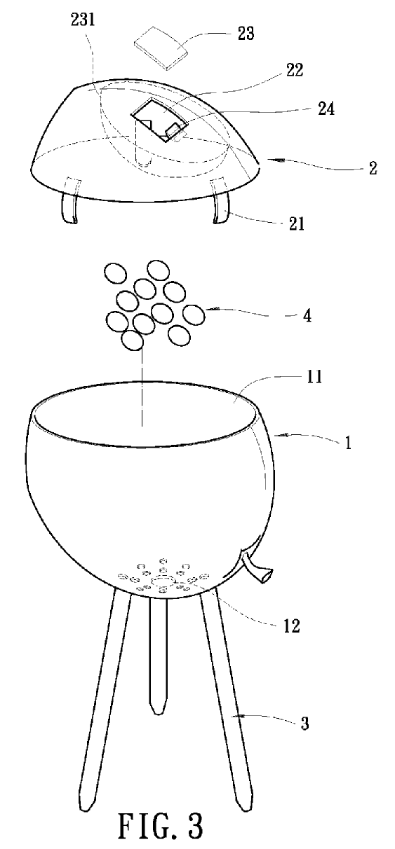

Referring to FIGS. 2 and 3, a first embodiment of a nutriment supplying device in accordance with the present invention comprises a container 1, a cover 2, and at least one positioning leg 3 (three in this embodiment). The container 1 receives fertilizer 4 and is covered by the cover 2. The positioning legs 3 extend from the container 1 and can be stuck into soil (not labeled) in a pot A in which a plant is planted, with a bottom of the container 1 in contact with a surface of the soil or buried in the soil. This avoids attraction to insects or generation of odor when nutriment resulting from dissolution of the fertilizer passes through drain holes 12 in the bottom of the container 1 into the soil. The container 1 and the cover 2 may be of a shape of an animal, a plant, or an artificial mountain to decorate the potted plant. In this embodiment, the nutriment supplying device is peach-shaped (fruit shape).

Still referring to FIG. 3, the container 1 includes an opening 11 and a plurality of drain holes 12. The opening 11 allows a user to place fertilizer 4 into the container 1. The drain holes 12 are defined in a bottom of the container 1 for draining liquid in the container 1. The size and number of the drain holes 12 can be selected by the user according to need to increase or reduce the draining speed.

Still referring to FIG. 3, the cover 2 is mounted to and thus covers the opening 11 of the container 1. The cover 2 includes at least one coupling member 21 (three in this embodiment), a liquid inlet 22, a lid 23, and a support 24. The coupling members 21 guide and attach the cover 2 to the container 1. The number and size of the coupling members 21 can be selected according to need. In this embodiment, the coupling members 21 are arcuate plates coupled to an inner edge of the opening 11 of the container 1. Further, the coupling members 21 may include a chain (not shown) for linking a side of the container 2 to a wall defining the opening 11 of the container 1, allowing opening/closing of the opening 11 of the container 1. Alternatively, the coupling members 21 may be mounted to a perimeter edge of the container 1 (or the cover 2) for engagement with the cover 2 (or the container 1).

Still referring to FIG. 3, the liquid inlet 22 is defined in a top of the cover 2 for filling liquid. The lid 23 is coupled to the liquid inlet 22 and supported by the support 24. The support 24 may have any desired shape. In this embodiment, the support 24 is a hinge portion that provides an automatic returning effect. The lid 23 can be manually opened, and the lid 23 is automatically returned to its original closed position when the force applied to the lid 23 is released. The size of the lid 23 is smaller than that of the liquid inlet 22, allowing rainwater to enter the container 1 via a gap (not labeled) between a perimeter wall defining the liquid inlet 22 and the lid 23. Further, a screen 231 is provided in the cover 2 and behind the lid 23 for preventing insects from entering the container 1 via the gap between the lid 23 and the perimeter wall defining the liquid inlet 22. Alternatively, the screen 231 may be located in and fully covers the liquid inlet 22.

Still referring to FIG. 3, in assembly of the first embodiment of the nutriment supplying device in accordance with the present invention, the screen 231 is attached to the cover 2 in a position behind the lid 23, with a perimeter of the screen 231 surrounding the lid 23 that is engaged in the liquid inlet 22 of the cover 2 by the support 24. The positioning legs 3 are fixed to the bottom of the container 1. The cover 2 is then attached to the opening 11 of the container 11 by the coupling members 21.

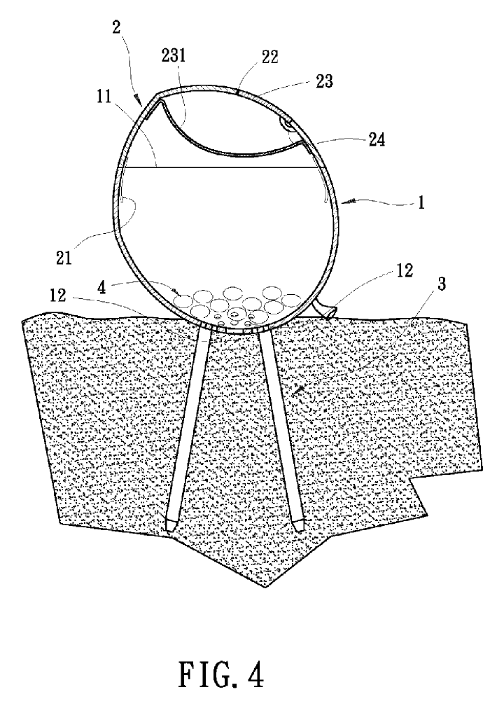

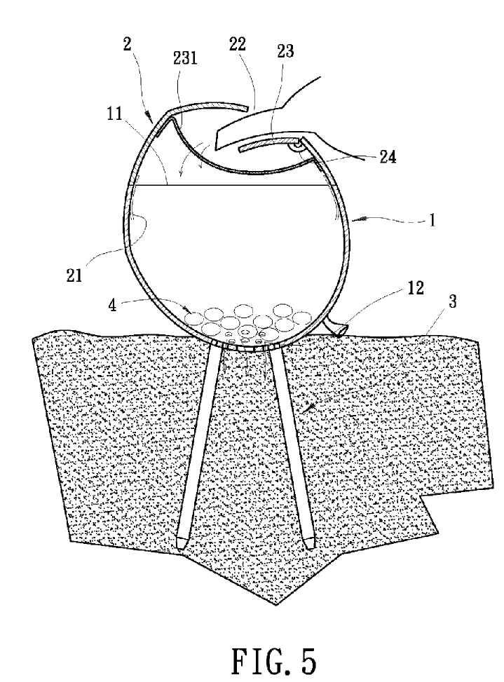

Referring to FIGS. 4 and 5, in use, the cover 2 is removed from the container 1 for filling fertilizer 4 and then placed back to the opening 11. Next, the positioning legs 3 are stuck into the soil of a pot A in which a plant is planted (see FIG. 2). Next, a user may use a nose (not labeled) of a watering tool (not labeled) to push the lid 23 inward into the cover 2, with the nose passing through the liquid inlet 22, allowing liquid (such as water) to pour into the container 1 via the screen 231. After watering, the lid 23 returns to its original position under the action of the support 24 when the watering tool leaves the liquid inlet 22. The liquid poured into the container 1 dissolves the fertilizer 4 and the liquid mixture containing the fertilizer permeates the soil in the pot A. The drain holes 12 may slow down the draining speed of the liquid mixture. Hence, the fertilizer may dissolve well in the liquid.

Still referring to FIGS. 4 and 5, the first embodiment of the nutriment supplying device in accordance with the present invention also allows rainwater to enter the container 1 via the gap (not labeled) between the perimeter wall defining the liquid inlet 22 and the lid 23 for dissolving the fertilizer 4, allowing flexible and convenient use.

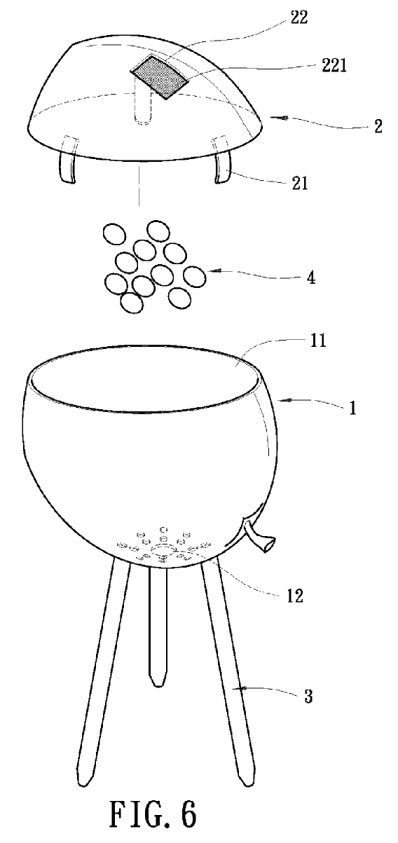

FIG. 6 illustrates a second embodiment of the nutriment supplying device in accordance with the present invention. In this embodiment, a screen 221 is provided in and thus seals the liquid inlet 22 whereas the lid 23 and the support 24 in the first embodiment are omitted. Insects are thus kept out of the container 1. Further, when it rains, the rainwater directly enters the container 1 through the screen 221 and liquid inlet 22 for dissolving the fertilizer 4, allowing flexible and convenient use. The watering tool (see FIG. 2) is not limited to the type having a nose that is used to push the lid 23 in the first embodiment. Liquid may be directly poured into the container 1 from above the cover 2, allowing flexible and convenient use.

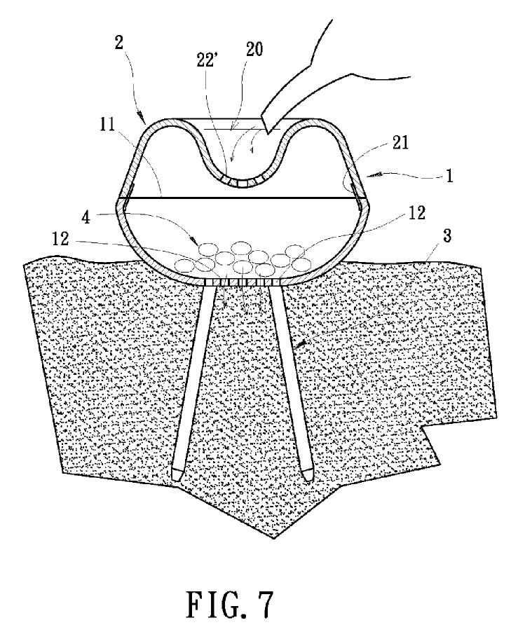

FIG. 7 illustrates a third embodiment of the nutriment supplying device in accordance with the present invention. In this embodiment, the cover 2 includes a recessed portion 20 with a plurality of liquid inlets 22′ defined in a bottom wall of the recessed portion 20. The size of the liquid inlets 22′ is small enough to keep insects out of the container 1. Further, when liquid is poured into the container 1, the liquid can be directly poured into the recessed portion 20 and then drained into the container via the liquid inlets 22′. Thus, manual watering or rainwater can be used while effectively keeping insects out of the container 1. The manufacturing process for the cover is simplified while enhancing assembling convenience and environmental quality.

Referring to FIGS. 2 through 7, the fertilizer 4 can be kept in the container 1 and the cover 2 in the first, second, and third embodiments without the risk of attracting insects and generating odor, thereby improving hygiene. Further, the shape (e.g., the peach shape) of the container 1 and the cover 2 may decorate the potted plant. Further, the drain holes 12 in the container 1 may slow down the draining speed of the liquid mixture, allowing sufficient dissolution of the fertilizer 4 and thereby increasing the nutriment for the plant. Further, the lid 23 and the screen 231 in the first embodiment, the screen 221 in the second embodiment, and the liquid inlets 22′ in the third embodiment may effectively keep insects out of the container 1 while allowing convenient pouring of water into the container. The environmental quality is enhanced and convenient use is allowed.

As apparent from the foregoing, the disadvantages of the prior art fertilizing method are avoided by the nutriment supplying devices in accordance with the present invention.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A nutriment supplying device for plants, comprising:
a container including an opening and a plurality of drain holes, the container being adapted for receiving fertilizer; and
a cover mounted to the opening, the cover including at least one liquid inlet through which liquid is filled into the container, the cover further including a lid for opening and automatically closing the liquid inlet to allow a watering tool to fill the liquid and to keep insects out of the container, respectively;
wherein the liquid in the container dissolves the fertilizer and is then drained via the drain holes to provide nutriment for a potted plant.

2. The nutriment supplying device for plants as claimed in claim 1 further comprising at least one support for retaining the lid in the liquid inlet.

3. The nutriment supplying device for plants as claimed in claim 1 further comprising a screen attached to the cover and behind the lid for preventing insects from entering the container via a gap between a perimeter wall defining the liquid inlet and the lid.

4. The nutriment supplying device for plants as claimed in claim 1 further comprising a screen mounted in the liquid inlet for preventing insects from entering the container.

5. The nutriment supplying device for plants as claimed in claim 1 further comprising at least one coupling member for guiding and attaching the cover to the container.

6. The nutriment supplying device for plants as claimed in claim 1, wherein the lid further includes a recessed portion, the recessed portion including a bottom wall with a plurality of liquid inlets.

7. The nutriment supplying device for plants as claimed in claim 1, wherein the container further includes at least one leg to be stuck into soil in a pot in which the potted plant is planted.

8. The nutriment supplying device for plants as claimed in claim 1, wherein the cover and the container together form a shape of an animal, a plant, or an artificial mountain to decorate the potted plant.
